(19) United States
(12) Patent Application Publication
(10) Pub. No.: US 2025/0151762 A1
(43) Pub. Date: May 15, 2025

(54) SYSTEM, PROCESS, AND COMPOSITION FOR FLAVORING SNACK FOOD

(71) Applicant: Performance Food Group, Inc., Richmond, VA (US)

(72) Inventors: Andrea Marie Krug Plucker, Castle Rock, CO (US); Wesley Herbert Giebelman, Utica, NE (US); Josephine Elin Houston, Lincoln, NE (US)

(21) Appl. No.: 18/509,001

(22) Filed: Nov. 14, 2023

(51) Int. Cl. A23L 7/191; A23G 3/34; A23P 20/10; A23P 20/12

(52) U.S. Cl. CPC A23L 7/191; A23G 3/343; A23P 20/11; A23P 20/12

(57) ABSTRACT

A method for making a popped snack food is disclosed. The method includes mixing a dry carbonated mixture including a dry sugar in an amount of between 20% and 50% by weight, a dry seasoning in an amount of between 5% and 28% by weight, and a dry carbonated popping candy in an amount of between 40% and 65% by weight, coating a popped base product with an oil mixture, and coating the popped base product, which is freshly coated with the oil mixture, with the dry carbonated mixture.

### TECHNICAL FIELD

The present disclosure generally relates to a system, process, and composition for snack food, and more particularly to a system, process, and composition for flavoring snack food.

### BACKGROUND

Snack foods such as popcorn are often produced to provide snacks of varying flavors to consumers. Depending on the desired flavor, various ingredients are typically added to the popcorn to provide suitable taste.

Challenges exist with conventional systems in providing certain types of flavored popcorn. For example, popcorn flavored or modified to have certain candy or sugary tastes may be difficult to provide without either negatively affecting a candy or sugary taste of the snack food or adding moisture to a snack food such as popcorn coated with popping candy.

For example, conventional techniques for providing flavored popcorn do not adequately provide for preserving both a desired candy or sugary taste and also maintaining the popcorn in a desirable, relatively dry condition. That is, when conventional techniques are used to provide flavored popcorn coated for example with popping candy, the popcorn typically becomes moist or wet over time within its packaging. Snack foods having certain candy or sugary tastes produced using conventional techniques often perform poorly in humid environments.

The exemplary disclosed system, process, and composition of the present disclosure are directed to overcoming one or more of the shortcomings set forth above and/or other deficiencies in existing technology.

### SUMMARY OF THE DISCLOSURE

In one exemplary aspect, the present disclosure is directed to a method for making a popped snack food. The method includes mixing a dry carbonated mixture including a dry sugar in an amount of between 20% and 50% by weight, a dry seasoning in an amount of between 5% and 28% by weight, and a dry carbonated popping candy in an amount of between 40% and 65% by weight, coating a popped base product with an oil mixture, and coating the popped base product, which is freshly coated with the oil mixture, with the dry carbonated mixture.

In another aspect, the present disclosure is directed to a dry carbonated composition for coating a popped popcorn that is coated with an oil mixture. The dry carbonated composition includes a dry sugar in an amount of between 20% and 50% by weight, a dry seasoning in an amount of between 5% and 28% by weight, and a dry carbonated popping candy in an amount of between 40% and 65% by weight.

### BRIEF DESCRIPTION OF THE DRAWINGS

FIG. 1 is a top view of an exemplary embodiment of the present invention;

FIG. 2 is a side view of the exemplary embodiment of FIG. 1;

FIG. 3 is a detailed, top view of the exemplary embodiment of FIG. 1;

FIG. 4 is another detailed, top view of the exemplary embodiment of FIG. 1;

FIG. 5 illustrates an exemplary process of at least some exemplary embodiments of the present disclosure;

FIG. 6 is a schematic illustration of a step of the exemplary process of FIG. 5; and

FIG. 7 is a schematic illustration of another step of the exemplary process of FIG. 5.

### DETAILED DESCRIPTION AND INDUSTRIAL APPLICABILITY

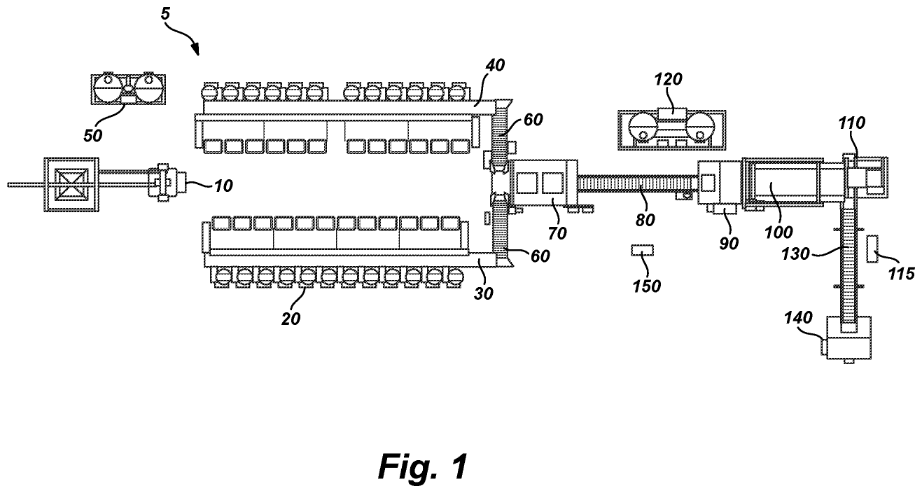

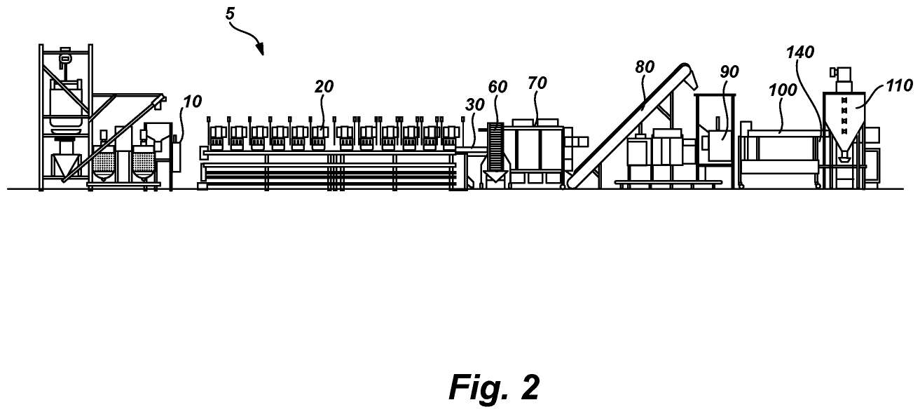

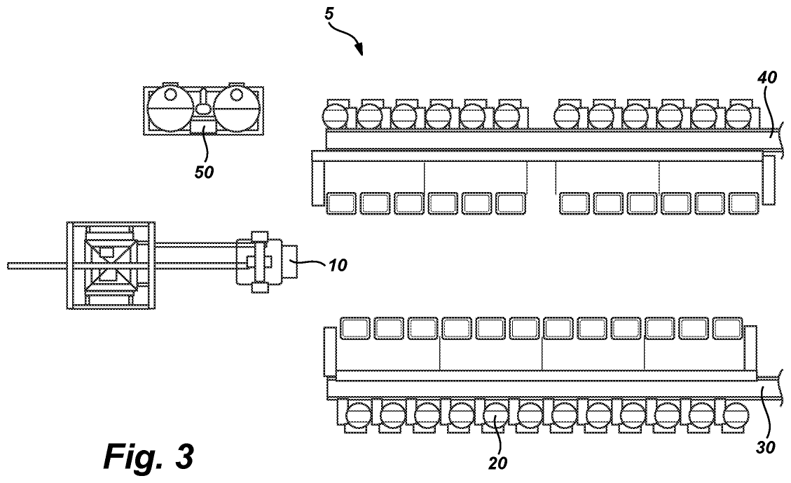

The exemplary disclosed system, process, and composition may produce a snack food (e.g., a flavored snack food) such as, for example, popcorn, popped grains, puffed snacks (e.g., flavored puffs, vegetable puffs, cheese puffs, and/or any other suitable type of puff), potato chips, tortilla chips, corn chips, pita chips, vegetable chips, pork rinds, bean chips, and/or any other suitable type of snack food. The snack food may be a popped snack food. In at least some exemplary embodiments, the exemplary disclosed system may produce popped popcorn such as, for example, kettle corn or any other suitable type of sweet-tasting popcorn. System 5, an exemplary embodiment of the exemplary disclosed system, is illustrated in FIGS. 1-4. System 5 may include a plurality of machines that may be arranged relative to each other to produce the exemplary disclosed snack food, for example as described below.

System 5 may include an unloading assembly 10. Unloading assembly 10 may be a bulk bag unloading assembly. In at least some exemplary embodiments, unloading assembly 10 may be an unloading assembly for corn to be popped by system 5 to produce popcorn. Unloading assembly 10 may for example include a raw corn elevator or any other suitable machine for loading bulk amounts of material (e.g., corn, grain, or any other desired base product) to be popped.

System 5 may also include one or more (e.g., a plurality of) popping assemblies 20. Popping assembly 20 may be any suitable assembly for popping a base product (e.g., corn kernels, grain, or other suitable snack food ingredient) such as, for example, popcorn. Popping assembly 20 may be any suitable wet-popping or air-popping device. In at least some exemplary embodiments, popping assembly 20 may be a wet popper such as a gas popping kettle. In at least some exemplary embodiments, popping assembly 20 may be an oil-popping device. For example, popping assembly 20 may be a stainless steel kettle including an oil pump. Popping assembly 20 may pop the base product using any suitable mixture (e.g., a mixture of oil, sugar, and base product) such as, for example, oil (e.g., sunflower oil), sugar, and popcorn to pop kettle corn. Any suitable number of popping assemblies 20 may be provided such as, for example, up to 20 or more popping assemblies 20. In at least some exemplary embodiments, 18 (eighteen) or 24 (twenty-four) popping assemblies 20 may be provided.

System 5 may also include a vibratory collection conveyor 30. Vibratory collection conveyor 30 may be any suitable conveyor for collecting popped base product that has been popped in popping assemblies 20. Vibratory collection conveyor 30 may catch, transport, and vibrate popped base product (e.g., popcorn) from popping assemblies 20 to an inclined conveyor 60 described below. Vibration collection conveyor 30 may include a movable, vibratory conveyor belt or any other suitable components for transporting and/or vibrating popped base product. System 5 may also include a vibratory conveyor 40 that may be similar to vibratory collection conveyor 30 and that may similarly transport and/or vibrate popped base product from popping assemblies 20 to inclined conveyor 60 described below.

System 5 may also include a first skid 50. First skid 50 may be any suitable oil skid. For example, first skid 50 may be an oil kettle skid of between about 10 and about 250 gallons or more (e.g., about 110 gallons or any other suitable volume). First skid 50 may be any suitable pressure vessel skid. First skid 50 may be a movable skid (e.g., including wheels, casters, or other suitable movable assemblies) that may be moved between popping assemblies 20 to provide oil to popping assemblies 20 to perform the popping operation of base product.

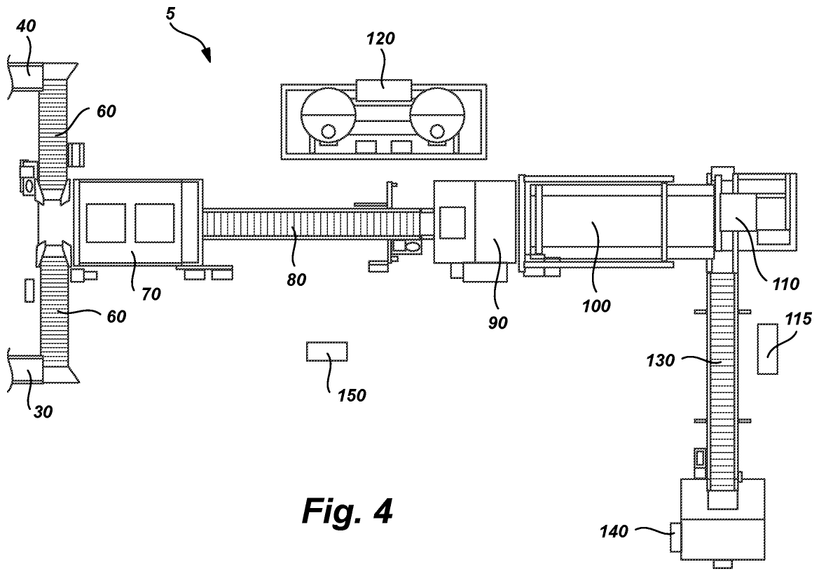

System 5 may also include one or more (e.g., a plurality of) inclined conveyors 60. For example, system 5 may include two inclined conveyors 60 for example as illustrated in FIGS. 1 and 4. Inclined conveyors 60 may have components similar to as described above regarding conveyors 30 and 40. Inclined conveyors 60 may include a belt or similar component that may be configured at an incline to transport popped base product from a relatively lower position (e.g., lower to a floor) of conveyors 30 and 40 to a relatively higher position of a sifter 70 described below.

Sifter 70 of system 5 may be disposed relatively higher than conveyors 30 and 40 in some exemplary embodiments and may perform a sifting operation on the popped base product. Sifter 70 may transfer the popped base product from inclined conveyors 60 to a second inclined conveyor 80 described below while sifting and/or cooling the popped base product. Sifter 70 may operate to remove hulls, unpopped base product, and/or undersized base product before transferring the popped base product to second inclined conveyor 80. Sifter 70 may be any suitable cooling sifter. For example, sifter 70 may include a rotating cylinder that may convey the base product to a chute that may deposit the base product on second inclined conveyor 80. The exemplary disclosed rotating cylinder may be a stainless steel mesh wire cylinder with helical flights for conveying base product. The exemplary disclosed chute may be a stainless steel tapered scrap chute. Sifter 70 may include any suitable type of cooling fan for cooling the popped base product such as a propeller fan.

Second inclined conveyor 80 of system 5 may be generally similar to inclined conveyors 60. Second inclined conveyor 80 may be taller than inclined conveyors 60 and transport popped base product to a relatively greater height from the floor than inclined conveyors 60. Second inclined conveyor 80 may transport popped base product that falls from the exemplary disclosed chute of sifter 70 to a position above a first storage container 90. For example, base product transported by second inclined conveyor 80 may be dropped from a top portion of second inclined conveyor 80 into first storage container 90. First storage container 90 may be any suitable storage container (e.g., a storage hopper) for storing popped base product such as, for example, a steel bin.

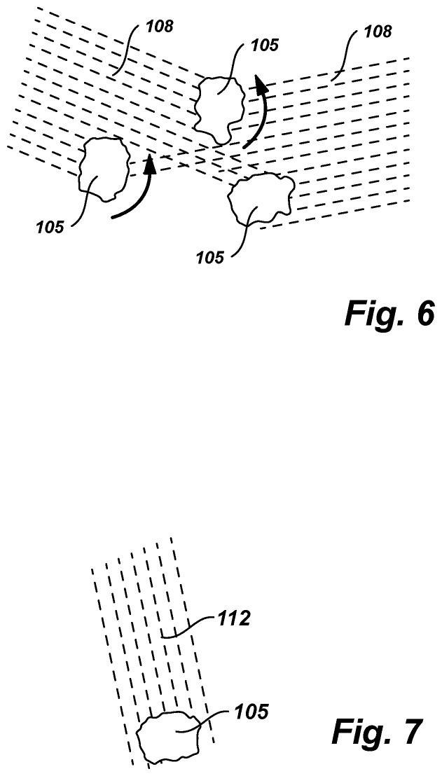

System 5 may also include a coater 100. Popped base product stored in first storage container 90 may be provided to coater 100 (e.g., moved via a hopper operation of first storage container 90, mechanically conveyed, transported, fed, and/or transported by any other suitable technique). Coater 100 (e.g., a savory coater) may be any suitable device for providing a coating to the popped base product. Coater 100 may be any suitable tumbler device for applying a coating. For example, coater 100 may be a stainless steel coating tumbler. Coater 100 may include one or more coating spraying and/or spreading devices (e.g., sprayers and/or spreaders). Coater 100 may include a drum that tumbles (e.g., gently tumbles) popped base product as it is coated. Coater 100 may apply coating material that may include an oil mixture of oil (e.g., sunflower oil), oil slurries, salt, and/or any other suitable ingredients for coating a popped base product. Coating materials (e.g., mixture) may be stored and provided to coater 100 from a second skid 120 (e.g., a slurry skid) that may be similar to first skid 50. In at least some exemplary embodiments, coater 100 may coat the popped base product by tumbling (e.g., gently tumbling) the popped base product as it sprays the exemplary disclosed coating material onto the popped base product (e.g., as schematically illustrated in FIG. 6).

Returning to FIGS. 1, 2, and 4, system 5 may also include a flavoring assembly 110. Coated base product that has been coated by coater 100 may be provided to flavoring assembly 110 (e.g., mechanically conveyed, transported, and/or or fed for example by a conveyor similar to the exemplary disclosed conveyors described above or any other suitable technique). Flavoring assembly 110 may be any suitable seasoner such as, for example, a dry seasoner. Flavoring assembly 110 may be any suitable device for applying an exemplary disclosed dry mixture described below onto the coated base product (e.g., unpopped base product that was coated by coater 100). Flavoring assembly 110 may drape the exemplary disclosed dry mixture onto the coated base product (e.g., onto the freshly sprayed based product that has been sprayed by coater 100). For example, flavoring assembly 110 may drape a curtain of the exemplary disclosed dry mixture onto the coated base product. For example, flavoring assembly 110 may apply a curtain of dry mixture onto the freshly coated base product that was coated by coater 100. In at least some exemplary embodiments, flavoring assembly 110 may include a dry seasoning drum that tumbles the coated base product as the exemplary disclosed dry mixture is applied (e.g., as schematically illustrated in FIG. 7).

Returning to FIGS. 1 and 4, system 5 may also include a pre-batching assembly 115 that may be used to prepare the exemplary disclosed dry mixture that may be applied by flavoring assembly 110 to the coated base product (e.g., unpopped base product that was previously freshly coated by coater 100). Pre-batching assembly 115 may be any suitable device for mixing and preparing a dry mixture such as, for example, any suitable mixer, blender, or other mixing device. Pre-batching assembly 115 may be a commercial mixer. In at least some exemplary embodiments, pre-batching assembly 115 may be disposed on a skid that may be similar to skids 50 and 120. The exemplary disclosed dry mixture prepared by pre-batching assembly 115 may be provided to flavoring assembly 110 as flavoring assembly 110 applies the dry mixture to the coated base product.

The exemplary disclosed dry mixture mixed by pre-batching assembly 115 may be a powdery mixture (e.g., a fine grade dry mixture). The dry mixture may be a carbonated mixture (e.g., a dry carbonated mixture such as a dry carbonated candy mixture). FIG. 7 schematically illustrates the exemplary disclosed dry mixture. The dry mixture may be pre-batched (e.g., mixed) using pre-batching assembly 115. As further described below, the dry mixture may include candy, sweetener, and flavoring. In at least some exemplary embodiments and as further described below, the dry mixture may include candy, sweetener, flavoring, and salt.

System 5 may also include a third conveyor 130 that may be similar to conveyors 30, 40, 60, and/or 80. Third conveyor 130 may move the base product that has been coated by coater 100 and flavoring assembly 110 to be packaged by any suitable packaging devices. In at least some exemplary embodiments, third conveyor 130 may move (e.g., swiftly move) the popped, coated base product to be packaged. The snack food (e.g., popped, coated base product) may for example be stored in second storage container 140 (e.g., a second storage bin), which may be similar to first storage container 90, prior to beginning the packaging process. For example, the packaging process may include a nitrogen flush and/or any other suitable processing to maintain a desired dryness of the snack food. For example, the coated base product may be processed and packaged as snack food so that it maintains a product moisture of under about 2.5% (e.g., to provide candy carbonation stability such as when the dry mixture includes a carbonated candy).

System 5 may also include a controller 150 that may control the exemplary disclosed devices to provide an automated or semi-automated production process. Controller 150 may include a control panel. Controller 150 may control an operation of the exemplary disclosed devices of system 5. Controller 150 may include for example a processor (e.g., micro-processing logic control device) or board components. Also for example, controller 150 may include input/output arrangements that allow it to be connected (e.g., via wire, wireless, Wi-Fi, Bluetooth, or any other suitable communication technique) to other devices and components of system 5. Controller 150 may include a user interface such as a control panel including buttons and switches, a keypad, a touchscreen, voice control interface, and/or any other suitable user interface. For example, controller 150 may control an operation of the exemplary controlled devices based on input received from a user via controller 150 and/or based on predetermined algorithms or instructions.

The exemplary disclosed system, process, and composition may be used in any suitable application for providing a flavored snack food. For example, the exemplary disclosed system, process, and composition may be used in any suitable application for providing a flavored popcorn such as kettle corn. The exemplary disclosed system, process, and composition may be used in any suitable application for providing a snack food having a popping candy taste.

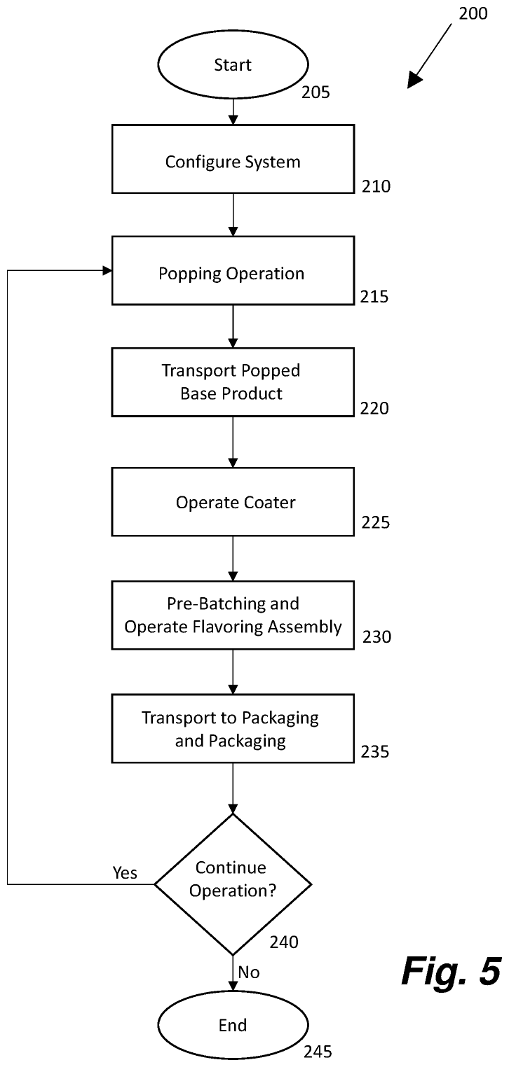

FIG. 5 illustrates an exemplary operation of the exemplary disclosed system 5. Process 200 begins at step 205. At step 210, system 5 may be configured (e.g., for example as illustrated in FIGS. 1-4 or in any other suitable configuration for preparing a snack food).

At step 215, a popping operation may be performed. One or more popping assemblies 20 may pop base product into popped base product. In at least some exemplary embodiments, popping assemblies 20 may pop the base product using a mixture of oil, sugar, and base product (e.g., popcorn) to pop a popped base product (e.g., kettle corn).

At step 220, the popped base product may be transported and cooled. Conveyors 30 and 40 may transport the popped base product to inclined conveyors 60, which may transport the popped base product to sifter 70. Sifter 70 may cool the popped base product and remove hulls, unpopped base product, and/or undersized base product from the base product. Second inclined conveyor 80 may transport the popped base product from sifter 70 to first storage container 90.

At step 225, the popped base product may be transported from first storage container 90 to coater 100 for example as described above. For example as illustrated in FIG. 6, coater 100 may apply a coating material 108 that may include a mixture of oil, oil slurries, salt, coloring (e.g., color), flavoring, and/or any other suitable ingredients for coating a popped base product 105. Coating material 108 may be flavored or unflavored (e.g., may contain flavoring ingredients such as sweeteners, seasoning, and/or any other suitable ingredients). Coater 100 may tumble popped base product 105 as coating material 108 is sprayed on popped base product 105. In at least some exemplary embodiments, coater 100 may spray coating material 108 that may be an oil coating on popped base product 105 that may be kettle corn. Coating material 108 (e.g., mixture including oil) may be at any suitable temperature as the coating is applied such as, for example, an ambient temperature up to about 80° F. (e.g., between about 60° F. and about 80° F.). The coating material (e.g., mixture) may be provided to coater 100 from second skid 120.

At step 230, pre-batching assembly 115 may perform pre-batching and flavoring assembly 110 may perform flavoring. Pre-batching may be performed by pre-batching assembly 115 to provide the exemplary disclosed dry mixture to be applied during the operation of flavoring assembly 110.

The exemplary disclosed dry mixture may be a dry, powdery seasoning and/or candy mixture. The mixture may be a dry carbonated mixture. The mixture may be a dry carbonated candy mixture. The dry mixture may include a candy, a sweetener, and a flavoring.

The candy of the exemplary disclosed dry mixture may be a carbonated candy. The candy may include pressurized carbon dioxide gas bubbles that may be embedded in the candy, which may produce a popping effect or reaction when dissolved (e.g., when users put the candy in their mouths). The candy may be a popping candy. The candy may be a dry carbonated popping candy. The candy may be soda candy, carbonated candy, popping sugar, and/or fizzy candy. The candy may be flavored or unflavored. The candy may have a soda taste, a fruit taste, and/or any desired type of candy taste (e.g., peppermint, bubble gum, chocolate, caramel, ice cream, and/or any other desired taste). The exemplary disclosed dry mixture may be between about 40% and about 65% candy (e.g., popping candy) by weight, between about 40% and about 60% candy (e.g., popping candy) by weight, between about 45% and about 65% candy (e.g., popping candy) by weight, between about 50% and about 65% candy (e.g., popping candy) by weight, between about 42% and about 58% candy (e.g., popping candy) by weight, between about 42% and about 50% candy (e.g., popping candy) by weight, between about 45% and about 55% candy (e.g., popping candy) by weight, between about 50% and about 60% candy (e.g., popping candy) by weight, or between about 54% and about 59% candy (e.g., popping candy) by weight.

The sweetener of the exemplary disclosed dry mixture may include sugar, fruit-based sweeteners, and/or any suitable artificial sweetener or sugar substitute. The sweetener may be sugar such as powdered sugar (e.g., granulated sugar). The sweetener may be dry sugar. The sweetener may be cane sugar or beet sugar. The sweetener may be brown sugar. The exemplary disclosed dry mixture may be between about 20% and about 50% sweetener (e.g., sugar) by weight, between about 30% and about 50% sweetener (e.g., sugar) by weight, between about 20% and about 35% sweetener (e.g., sugar) by weight, between about 30% and about 40% sweetener (e.g., sugar) by weight, between about 32% and about 44% sweetener (e.g., sugar) by weight, between about 20% and about 28% sweetener (e.g., sugar) by weight, between about 25% and about 30% sweetener (e.g., sugar) by weight, between about 33% and about 45% sweetener (e.g., sugar) by weight, between about 40% and about 44% sweetener (e.g., sugar) by weight, or between about 34% and about 37% sweetener (e.g., sugar) by weight.

The flavoring of the exemplary disclosed dry mixture may include dry flavoring such as seasoning (e.g., dry seasoning). The flavoring may have a soda taste, a fruit taste, and/or any desired type of taste (e.g., peppermint, bubble gum, chocolate, caramel, ice cream, and/or any other desired taste). The flavoring may be dry soda seasoning. The flavoring may have any desired candy, dessert, or snack food taste. The flavoring may have any desired food taste (e.g., snack foods and food other than snack foods). The flavoring may be an unpleasant flavoring taste such as rotten eggs, wax, or other undesirable flavor for example in the case of a joke snack food. The exemplary disclosed dry mixture may be between about 5% and about 28% flavoring (e.g., seasoning) by weight, between about 10% and about 25% flavoring (e.g., seasoning) by weight, between about 5% and about 15% flavoring (e.g., seasoning) by weight, between about 5% and about 10% flavoring (e.g., seasoning) by weight, between about 6% and about 14% flavoring (e.g., seasoning) by weight, between about 7% and about 13% flavoring (e.g., seasoning) by weight, between about 15% and about 20% flavoring (e.g., seasoning) by weight, between about 20% and about 28% flavoring (e.g., seasoning) by weight, or between about 9% and about 13% flavoring (e.g., seasoning) by weight.

In at least some exemplary embodiments, the exemplary disclosed dry mixture may also include salt, and may thereby include candy, sweetener, flavoring, and salt. The type and amounts of candy, sweetener, and flavoring may be similar to as described above. The salt may be any suitable dry salt such as table salt (e.g., including NaCl). The exemplary disclosed dry mixture may be up to about 1% salt by weight, up to about 0.5% salt by weight, between about 0.5% and about 1% salt by weight, or between about 0.7% and about 0.9% salt by weight.

Coated popped base product 105 that has been coated by coater 100 may be provided to flavoring assembly 110 for example as described above. For example as illustrated in FIG. 7, flavoring assembly 110 may apply (e.g., drape or apply a curtain of) the exemplary disclosed dry mixture (e.g., a dry mixture 112) to popped base product 105 that was freshly coated with coating material 108 (e.g., an oil mixture) by coater 100. Flavoring assembly 110 may apply dry mixture 112 to popped base product 105 within a relatively short time period after popped base product 105 is freshly coated with coating material 108 by coater 100. The relatively short time period may be up to one minute, between about 2 seconds and about 30 seconds, between about 5 seconds and about 15 seconds (e.g., about 10 seconds), up to about 10 or 15 seconds, or any other suitable time period for adhering dry mixture 112 to popped base product 105 that has been coated with coating material 108 (e.g., an oil mixture). For example because of the relatively short time period between coating popped base product 105 with coating material 108 and applying dry mixture 112, coating material 108 may be wet when dry mixture 112 is applied and dry mixture 112 may thereby effectively adhere (e.g., adhere well) to popped base product 105. In at least some exemplary embodiments, dry mixture 112 may adhere to popped base product 105 freshly coated with coating material 108 without popping candy of dry mixture 112 being soluble in oil of coating material 108. Dry mixture 112 that may be a carbonated popping candy mixture may thereby be effectively adhered to popped base product 105 via spraying and seasoning for example as described above, without the use of a caramel process and/or candy drizzling. In at least some exemplary embodiments, dry mixture 112 may be composed (e.g., as described herein) so that a relatively dry popcorn coated with a carbonated dry mixture that retains its carbonation (e.g., fizz) may be produced in view of popcorn production factors (e.g., moisture, heat, and pressure) of process 200.

In at least some exemplary embodiments, based on the exemplary disclosed process, the popped base product may be coated with dry mixture 112 that may act as a desiccant and/or preservative that may preserve a carbonated effect of the dry mixture 112 (e.g., popping candy) while also maintaining a desired dryness of the popped base product (e.g., popcorn). For example, the coated popped base product (e.g. carbonated popcorn such as soda kettle corn) may maintain a fizz (e.g., even in humid environments) while also maintaining a relative dryness to the popped base product (e.g., keeps the popcorn from becoming moist or wet before and after packaging and storage).

Returning to FIG. 5 at step 235, the snack food (e.g., popped, coated base product) may be moved by third conveyor 130 to second storage container 140. The snack product may then be moved from second storage container 140 and through the packaging process.

At step 240, it may be determined whether or not to continue operation of system 5. The determination can be made, for example, based on user input to controller 150, predetermined operation of controller 150, a predetermined time period, and/or any other suitable criteria. If operation of system 5 is to continue, process 200 may return to step 215. Steps 215 through 240 may be performed for as many iterations as desired. As base product may be located throughout various parts of system 5 at any given time, some or all of steps 215 through 240 may be performed simultaneously regarding different portions of base product being processed. If operation of system 5 is not to continue, process 200 ends at step 245.

The following examples and experiments were conducted using system 5 to perform the steps of process 200 as described above.

### Example 1

Popping assemblies 20 performed popping (wet popping at step 215) using the below composition to pop kettle corn:

| | | | |
|---|---|---|---|
| Popcorn | 1400 | grams | 54.9% |
| Oil | 500 | grams | 19.6% |
| Sugar | 650 | grams | 25.5% |
| Total | 2550 | grams | 100.0% |

Coater 100 performed coating (at step 225) of the popped base product (kettle corn) using the below composition of coating material (slurry):

| | | | |
|---|---|---|---|
| Oil | 300 | grams | 99.8% |
| Flavor | 0.3 | grams | 0.1% (liquid flavor) |
| Color | 0.3 | grams | 0.1% (powder color) |
| Total | 300.6 | grams | 100.0% |

Pre-batching assembly 115 performed pre-batching to produce and flavoring assembly 110 performed flavoring using (at step 230) the below composition of dry mixture:

| | | | |
|---|---|---|---|
| Sugar | 50 | grams | 35.5% (powdered sugar) |
| Flavor | 10 | grams | 7.1% (powdered flavor) |
| Candy | 80 | grams | 56.7% (medium grind coated popping candy) |
| Salt | 1 | gram | 0.7% |
| Total | 141 | grams | 100.0% |

The final snack food recipe (coated, packaged) comprised 34.9% (150 grams) popped popcorn (kettle corn), 32.4% (139.2 grams) liquid slurry, and 32.7% (141 grams) dry mixture. Good flavor and good fizz of the snack food were noted.

### Example 2

Popping assemblies 20 performed popping (wet popping at step 215) using the below composition to pop kettle corn:

| | | | |
|---|---|---|---|
| Popcorn | 1400 | grams | 54.9% |
| Oil | 500 | grams | 19.6% |
| Sugar | 650 | grams | 25.5% |
| Total | 2550 | grams | 100.0% |

Coater 100 performed coating (at step 225) of the popped base product (kettle corn) using the below composition of coating material (slurry):

| | | | |
|---|---|---|---|
| Oil | 300 | grams | 99.8% |
| Flavor | 0.3 | grams | 0.1% (liquid flavor) |
| Color | 0.3 | grams | 0.1% (powder color) |
| Total | 300.6 | grams | 100.0% |

Pre-batching assembly 115 performed pre-batching to produce and flavoring assembly 110 performed flavoring using (at step 230) the below composition of dry mixture:

| | | | |
|---|---|---|---|
| Sugar | 50 | grams | 27.6% (powdered sugar) |
| Flavor | 30 | grams | 16.6% (powdered flavor) |
| Candy | 100 | grams | 55.2% (medium grind coated popping candy) |
| Salt | 1 | gram | 0.6% |
| Total | 181 | grams | 100.0% |

The final snack food recipe (coated, packaged) comprised 28.9% (150 grams) popped popcorn (kettle corn), 36.2% (187.4 grams) liquid slurry, and 34.9% (181 grams) dry mixture. Good flavor and good fizz of the snack food were noted.

### Example 3

Popping assemblies 20 performed popping (wet popping at step 215) using the below composition to pop kettle corn:

| | | | |
|---|---|---|---|
| Popcorn | 1400 | grams | 54.9% |
| Oil | 500 | grams | 19.6% |
| Sugar | 650 | grams | 25.5% |
| Total | 2550 | grams | 100.0% |

Coater 100 performed coating (at step 225) of the popped base product (kettle corn) using the below composition of coating material (slurry):

| | | | |
|---|---|---|---|
| Oil | 300 | grams | 99.8% |
| Flavor | 0.3 | grams | 0.1% (liquid flavor) |
| Color | 0.3 | grams | 0.1% (powder color) |
| Total | 300.6 | grams | 100.0% |

Pre-batching assembly 115 performed pre-batching to produce and flavoring assembly 110 performed flavoring using (at step 230) the below composition of dry mixture:

| | | | |
|---|---|---|---|
| Sugar | 50 | grams | 27.5% (powdered sugar) |
| Flavor | 30 | grams | 16.5% (powdered flavor) |
| Candy | 100 | grams | 55.2% (medium grind coated popping candy) |
| Salt | 1.5 | gram | 0.8% |
| Total | 181.5 | grams | 100.0% |

The final snack food recipe (coated, packaged) comprised 32.2% (150 grams) popped popcorn (kettle corn), 28.8% (133.8 grams) liquid slurry, and 39.0% (181.5 grams) dry mixture. The snack food was noted to be a good sample.

### Example 4

Popping assemblies 20 performed popping (wet popping at step 215) using the below composition to pop kettle corn:

| | | | |
|---|---|---|---|
| Popcorn | 1400 | grams | 54.9% |
| Oil | 500 | grams | 19.6% |
| Sugar | 650 | grams | 25.5% |
| Total | 2550 | grams | 100.0% |

Coater 100 performed coating (at step 225) of the popped base product (kettle corn) using the below composition of coating material (slurry):

| | | | |
|---|---|---|---|
| Oil | 300 | grams | 99.8% |
| Flavor | 0.3 | grams | 0.1% (liquid flavor) |
| Color | 0.3 | grams | 0.1% (powder color) |
| Total | 300.6 | grams | 100.0% |

Pre-batching assembly 115 performed pre-batching to produce and flavoring assembly 110 performed flavoring using (at step 230) the below composition of dry mixture:

| | | | |
|---|---|---|---|
| Sugar | 50 | grams | 24.6% (powdered sugar) |
| Flavor | 50 | grams | 24.6% (powdered flavor) |
| Candy | 100 | grams | 49.3% (medium grind coated popping candy) |
| Salt | 3 | gram | 1.5% |
| Total | 203 | grams | 100.0% |

The final snack food recipe (coated, packaged) comprised 31.9% (150 grams) popped popcorn (kettle corn), 25.6% (120.3 grams) liquid slurry, and 42.5% (200 grams) dry mixture. The snack food was noted to be a good sample.

### Example 5

Popping assemblies 20 performed popping (wet popping at step 215) using the below composition to pop kettle corn:

| | | | |
|---|---|---|---|
| Popcorn | 1400 | grams | 54.9% |
| Oil | 500 | grams | 19.6% |
| Sugar | 650 | grams | 25.5% |
| Total | 2550 | grams | 100.0% |

Coater 100 performed coating (at step 225) of the popped base product (kettle corn) using the below composition of coating material (slurry):

| | | | |
|---|---|---|---|
| Oil | 300 | grams | 99.8% |
| Flavor | 0.3 | grams | 0.1% (liquid flavor) |
| Color | 0.3 | grams | 0.1% (powder color) |
| Total | 300.6 | grams | 100.0% |

Pre-batching assembly 115 performed pre-batching to produce and flavoring assembly 110 performed flavoring using (at step 230) the below composition of dry mixture:

| | | | |
|---|---|---|---|
| Sugar | 50 | grams | 31.1% (powdered sugar) |
| Flavor | 10 | grams | 6.2% (powdered flavor) |
| Candy | 100 | grams | 62.1% (medium grind coated popping candy) |
| Salt | 1 | gram | 0.6% |
| Total | 161 | grams | 100.0% |

The final snack food recipe (coated, packaged) comprised 29.2% (150 grams) popped popcorn (kettle corn), 35.6% (183 grams) liquid slurry, and 35.2% (181 grams) dry mixture. The snack food was noted to have good flavor and to be slightly oily, and it was noted that the amount of candy may be reduced, if desired, as in the above examples.

In at least some exemplary embodiments, the exemplary disclosed method may be a method for making a popped snack food, including mixing a dry carbonated mixture including a dry sugar in an amount of between 20% and 50% by weight, a dry seasoning in an amount of between 5% and 28% by weight, and a dry carbonated popping candy in an amount of between 40% and 65% by weight, coating a popped base product with an oil mixture, and coating the popped base product, which is freshly coated with the oil mixture, with the dry carbonated mixture. The popped base product may be kettle corn. The method may also include coating the popped base product, which is freshly coated with the oil mixture, with the dry carbonated mixture within 10 seconds of coating the popped base product with the oil mixture. The dry seasoning may be dry soda seasoning. Coating the popped base product with the dry carbonated mixture may include draping a curtain of the dry carbonated mixture onto the popped base product. Coating the popped base product with the dry carbonated mixture may include draping a curtain of the dry carbonated mixture onto the popped base product by tumbling the popped base product in a drum. Coating the popped base product with the oil mixture may include coating the popped base product with the oil mixture that is at a temperature of between 60° F. and 80° F. The dry sugar may be in an amount of between 30% and 50% by weight, the dry seasoning may be in an amount of between 5% and 15% by weight, and the dry carbonated popping candy may be in an amount of between 40% and 60% by weight. The dry sugar may be in an amount of between 33% and 45% by weight, the dry seasoning may be in an amount of between 7% and 13% by weight, and the dry carbonated popping candy may be in an amount of between 42% and 58% by weight. The dry sugar may be in an amount of between 40% and 44% by weight, the dry seasoning may be in an amount of between 9% and 13% by weight, and the dry carbonated popping candy may be in an amount of between 42% and 50% by weight. The dry sugar may be in an amount of between 20% and 28% by weight, the dry seasoning may be in an amount of between 20% and 28% by weight, and the dry carbonated popping candy may be in an amount of between 45% and 55% by weight. The dry sugar may be in an amount of between 34% and 37% by weight, the dry seasoning may be in an amount of between 6% and 8% by weight, and the dry carbonated popping candy may be in an amount of between 54% and 59% by weight. The method may also include including an amount of salt to the dry carbonated mixture that is up to 1% salt by weight of the dry carbonated mixture.

In at least some exemplary embodiments, the exemplary disclosed dry carbonated composition may be a composition for coating a popped popcorn that is coated with an oil mixture, including a dry sugar in an amount of between 20% and 50% by weight, a dry seasoning in an amount of between 5% and 28% by weight, and a dry carbonated popping candy in an amount of between 40% and 65% by weight. The dry sugar may be in an amount of between 30% and 50% by weight, the dry seasoning may be in an amount of between 5% and 15% by weight, and the dry carbonated popping candy may be in an amount of between 40% and 60% by weight. The dry sugar may be in an amount of between 20% and 35% by weight, the dry seasoning may be in an amount of between 10% and 25% by weight, and the dry carbonated popping candy may be in an amount of between 45% and 65% by weight. The dry sugar may be in an amount of between 25% and 30% by weight, the dry seasoning may be in an amount of between 15% and 20% by weight, and the dry carbonated popping candy may be in an amount of between 50% and 60% by weight. The composition may also include salt in an amount of up to 1% by weight.

In at least some exemplary embodiments, the exemplary disclosed method may be a method for making popcorn, including mixing a dry carbonated mixture including a dry sugar in an amount of between 25% and 30% by weight, a dry seasoning in an amount of between 15% and 20% by weight, and a dry carbonated popping candy in an amount of between 50% and 60% by weight, coating a popped popcorn with an oil mixture, and coating the popped popcorn, which is freshly coated with the oil mixture, with the dry carbonated mixture. The method may also include coating the popped popcorn, which is freshly coated with the oil mixture, with the dry carbonated mixture within 10 seconds of coating the popped popcorn with the oil mixture. Coating the popped popcorn with the dry carbonated mixture may include draping a curtain of the dry carbonated mixture onto the popped popcorn.

In at least some exemplary embodiments, the exemplary disclosed system, process, and composition may provide an efficient and effective system for providing a snack food having a desired taste. The exemplary disclosed system, process, and composition may provide a snack food having a desired candy and/or sugary taste while also maintaining the snack food in a substantially dry state. For example, the exemplary disclosed system, process, and composition may provide a popcorn having a desired taste of popping candy while maintaining the popcorn in a substantially dry state.

It will be apparent to those skilled in the art that various modifications and variations can be made to the exemplary disclosed system, process, and composition. Other embodiments will be apparent to those skilled in the art from consideration of the specification and practice of the exemplary disclosed system, process, and composition. It is intended that the specification and examples be considered as exemplary, with a true scope being indicated by the following claims.

What is claimed is:

1. A method for making a popped snack food, comprising:
mixing a dry carbonated mixture including
a dry sugar in an amount of between 20% and 50% by weight,
a dry seasoning in an amount of between 5% and 28% by weight, and
a dry carbonated popping candy in an amount of between 40% and 65% by weight;
coating a popped base product with an oil mixture; and
coating the popped base product, which is freshly coated with the oil mixture, with the dry carbonated mixture.

2. The method of claim 1, wherein the popped base product is kettle corn.

3. The method of claim 1, further comprising coating the popped base product, which is freshly coated with the oil mixture, with the dry carbonated mixture within 10 seconds of coating the popped base product with the oil mixture.

4. The method of claim 1, wherein the dry seasoning is dry soda seasoning.

5. The method of claim 1, wherein coating the popped base product with the dry carbonated mixture includes draping a curtain of the dry carbonated mixture onto the popped base product.

6. The method of claim 1, wherein coating the popped base product with the dry carbonated mixture includes draping a curtain of the dry carbonated mixture onto the popped base product by tumbling the popped base product in a drum.

7. The method of claim 1, wherein coating the popped base product with the oil mixture includes coating the popped base product with the oil mixture that is at a temperature of between 60° F. and 80° F.

8. The method of claim 1, wherein:
the dry sugar is in an amount of between 30% and 50% by weight,
the dry seasoning is in an amount of between 5% and 15% by weight, and
the dry carbonated popping candy is in an amount of between 40% and 60% by weight.

9. The method of claim 1, wherein:
the dry sugar is in an amount of between 33% and 45% by weight,
the dry seasoning is in an amount of between 7% and 13% by weight, and
the dry carbonated popping candy is in an amount of between 42% and 58% by weight.

10. The method of claim 1, wherein:
the dry sugar is in an amount of between 40% and 44% by weight,
the dry seasoning is in an amount of between 9% and 13% by weight, and
the dry carbonated popping candy is in an amount of between 42% and 50% by weight.

11. The method of claim 1, wherein:
the dry sugar is in an amount of between 20% and 28% by weight,
the dry seasoning is in an amount of between 20% and 28% by weight, and
the dry carbonated popping candy is in an amount of between 45% and 55% by weight.

12. The method of claim 1, wherein:
the dry sugar is in an amount of between 34% and 37% by weight,
the dry seasoning is in an amount of between 6% and 8% by weight, and
the dry carbonated popping candy is in an amount of between 54% and 59% by weight.

13. The method of claim 1, further comprising including an amount of salt to the dry carbonated mixture that is up to 1% salt by weight of the dry carbonated mixture

14. A dry carbonated composition for coating a popped popcorn that is coated with an oil mixture, comprising:
a dry sugar in an amount of between 20% and 50% by weight;
a dry seasoning in an amount of between 5% and 28% by weight; and
a dry carbonated popping candy in an amount of between 40% and 65% by weight.

15. The dry carbonated composition of claim 14, wherein:
the dry sugar is in an amount of between 30% and 50% by weight,
the dry seasoning is in an amount of between 5% and 15% by weight, and
the dry carbonated popping candy is in an amount of between 40% and 60% by weight.

16. The dry carbonated composition of claim 14, wherein:
the dry sugar is in an amount of between 20% and 35% by weight,
the dry seasoning is in an amount of between 10% and 25% by weight, and
the dry carbonated popping candy is in an amount of between 45% and 65% by weight.

17. The dry carbonated composition of claim 14, wherein:
the dry sugar is in an amount of between 25% and 30% by weight,
the dry seasoning is in an amount of between 15% and 20% by weight, and
the dry carbonated popping candy is in an amount of between 50% and 60% by weight.

18. The dry carbonated composition of claim 14, further comprising salt in an amount of up to 1% by weight.

19. A method for making popcorn, comprising:
mixing a dry carbonated mixture including
a dry sugar in an amount of between 25% and 30% by weight,
a dry seasoning in an amount of between 15% and 20% by weight, and
a dry carbonated popping candy in an amount of between 50% and 60% by weight;
coating a popped popcorn with an oil mixture; and
coating the popped popcorn, which is freshly coated with the oil mixture, with the dry carbonated mixture.

20. The method of claim 19, further comprising coating the popped popcorn, which is freshly coated with the oil mixture, with the dry carbonated mixture within 10 seconds of coating the popped popcorn with the oil mixture;
wherein coating the popped popcorn with the dry carbonated mixture includes draping a curtain of the dry carbonated mixture onto the popped popcorn.
